(19) United States
(12) Patent Application Publication
(10) Pub. No.: US 2024/0397285 A1
(43) Pub. Date: Nov. 28, 2024

(54) Method for Using a Mobile Address as Alternative to a Traditional Mailing Address in Mobile Applications

(71) Applicant: Franklin Mister Lartey, Marietta, GA (US)

(72) Inventor: Franklin Mister Lartey, Marietta, GA (US)

(21) Appl. No.: 18/323,478

(22) Filed: May 25, 2023

(51) Int. Cl. H04W 4/029

(52) U.S. Cl. CPC H04W 4/029

(57) ABSTRACT

A method for using a mobile address in replacement of, or in addition to a mailing address, to provide users with no traditional address the ability to access essential services such as banking, financing, education, health, etc., through apps installed in their mobile devices. This invention creates the concept of the “mobile address” which allows mobile users to be identified by their mobile address the same way they would be identified by their postal or mailing address (e.g., home, work, school, etc.). The mobile address can thus be used in any mobile application to reflect the agreement of the user to provide their geolocation coordinates to serve as address as they use the services offered by the app.

### BACKGROUND OF THE INVENTION

The concept of mailing or postal address is ubiquitous in developed countries, but not well structured in developing countries. Mailing or postal addresses are essential for the efficient delivery of mail and packages, and they play a critical role in modern society, reason why most mobile applications ask for the users' mailing address (e.g., home, work, school, etc.). In developed countries, postal addresses are typically standardized, and the postal service is reliable, which ensures that mail and packages are delivered to the correct addresses. For this reason, the mailing address serves as a means of user identification in many mobile applications, even when there is no intent to deliver mails to the related user address.

In developing countries, the use of mailing or postal addresses can be complicated due to various factors including standardization, accessibility, and reliability of postal services, as well as the impact of urbanization, informal settlements, and cultural practices. As a result, many users in developing countries do not have a mailing address to use in mobile applications, which results in their marginalization or the use of fake addresses in some cases.

The issue of individuals without a mailing address is not unique to developing countries. In developed countries, there are also millions of individuals who do not have a mailing address. This includes illegal immigrants or individuals who are living in remote areas, homeless, or living in informal settlements. In many cases, these individuals may rely on community organizations or outreach programs to receive mail or packages.

According to the Universal Postal Union, an estimated 4 billion people worldwide do not have access to a physical address. This lack of access can have significant impacts on individuals' ability to access essential services, such as healthcare, banking, and education. Addressing this unique challenge for mobile applications is the main claim made by the current invention.

### SUMMARY OF THE INVENTION

Many mobile applications require the user to enter their mailing address such as their home or work address, even when no mail or package is being sent to them. The address is generally used for marketing purposes or to verify the user's identity among others. Unfortunately, millions of people around the world own a mobile device but do not have access to a well-structured mailing address. The present invention proposes a method coined the mobile address, which involves the collection of geolocation coordinates of a user's mobile device to use as their mobile address in addition to, complement to, or replacement of the mailing address.

With the use of this invention, mobile applications will have the option of using another type of address in the validation or verification of the user's identity among others. In addition, the use of the mobile address will provide other marketing opportunities as the stored address will include records of the users' paths and behaviors.

The mobile address, object of this invention, can be used in addition to or replacement of the user's mailing address. It can also replace any combination of elements of a mailing address, including and not limited to home number, street name, apartment number, building number, suite number, address line 1, address line 2, city, state, province, zip code, postal code, post office box number, country, and continent. The combination replaced by the mobile address will be at the discretion of those skilled in the art. For example, an application can use the mobile address but still require the user's city, state, and country, while another application might use the mobile address and require no further address information.

The concept of a mobile address as the name indicates, is an address that includes elements that change constantly based on the user's always-changing location. As such, the mobile address is a collection of geographic coordinates allowing a system to identify the previous, current, or future location of a user. For example, such a system could identify the user's location every day at 3 a.m., which, if in the same proximity, could related to where the user lives or sleeps. The same information at 10 a.m. could indicate where the user works, etc. As a result, the user's mobile address could help infer not just the home location, but also the work address, school, and multiple other addresses.

The current invention provides a new method for using the geolocation coordinates of a mobile device as a form of address, under the appellation of mobile address or any other appellation that uses such coordinates as a form of user address. This invention can thus be used in replacement of, or in addition to the mailing address, just like the home address can be used in addition to or replacement of the work address.

### BRIEF DESCRIPTION OF DRAWINGS

The present invention is supported by a set of figures, which demonstrate several examples of its implementation. These figures are considered an integral part of the invention's specifications, providing visual representation of various aspects of the invention. Along with the detailed descriptions that follow, the figures serve to clarify and explain the principles underlying the present disclosure. Through these illustrations, readers can gain a better understanding of the invention's functionality and potential applications. Additionally, the figures provide a helpful reference for those seeking to implement the invention in their own work. As such, they are an important component of the overall invention and contribute to its comprehensiveness and usefulness.

FIG. 1 is a flow diagram illustrating an example method for the user's selection of a mobile address, object of the present invention.

FIG. 2 is an illustration depicting an example for storing users' election to use a mobile address in database tables; it also shows how to store their related location information in various tables.

FIG. 3 is an example of a user interface in which the user can enter their mailing address or select to use their mobile address.

FIG. 4 is a flow diagram representing an example method for the use of the invention in a process where the user is required to have an address or provide their current location coordinates prior to executing the action.

FIG. 5 is a flow diagram showing a situation where the mobile address is triggered either continuously, randomly, or at a scheduled time to capture the user's mobile location and add the information to their mobile address.

### DETAILED DESCRIPTION OF THE INVENTION

The purpose of the following description is to provide guidance to individuals with understanding or expertise in the relevant field, so that they can implement and utilize the invention. The specific application outlined in this description is intended to provide context and illustrate the invention's capabilities, but it should be understood that the principles underlying the invention can be applied in a variety of other contexts. Skilled practitioners in the field will be able to modify the embodiments described herein to suit their needs and create new applications based on the same principles.

It is important to note that the invention is not limited to the particular embodiments or applications presented in this description. Rather, the principles and features described here should be understood as broadly applicable to other embodiments and applications, and the scope of the invention should be interpreted accordingly. To achieve its full potential, the invention must be afforded the broadest possible interpretation consistent with its underlying principles.

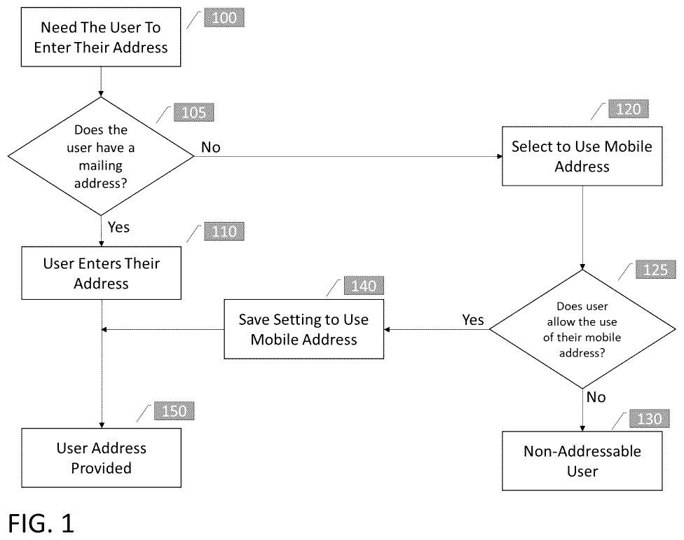

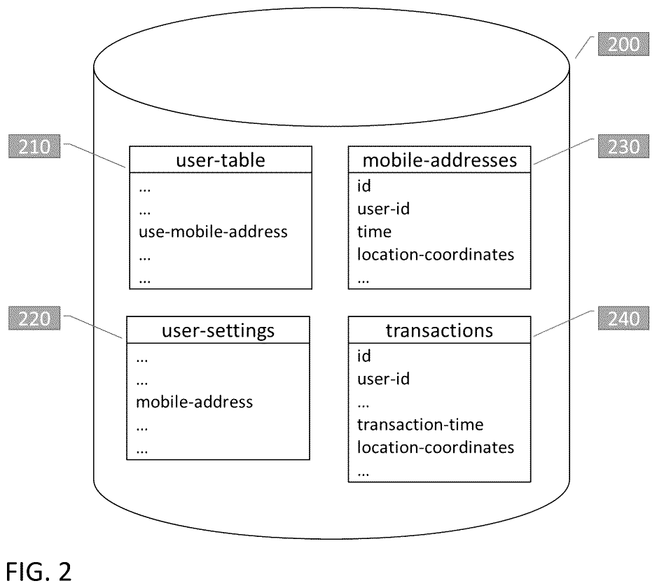

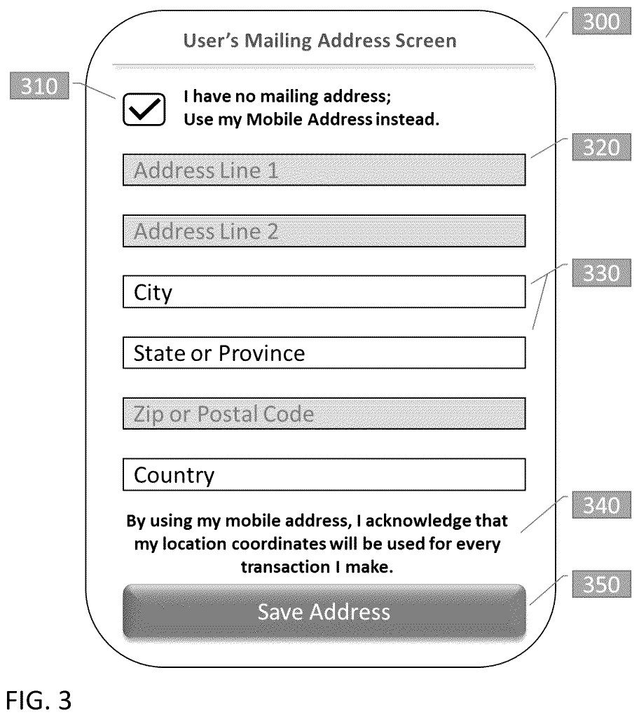

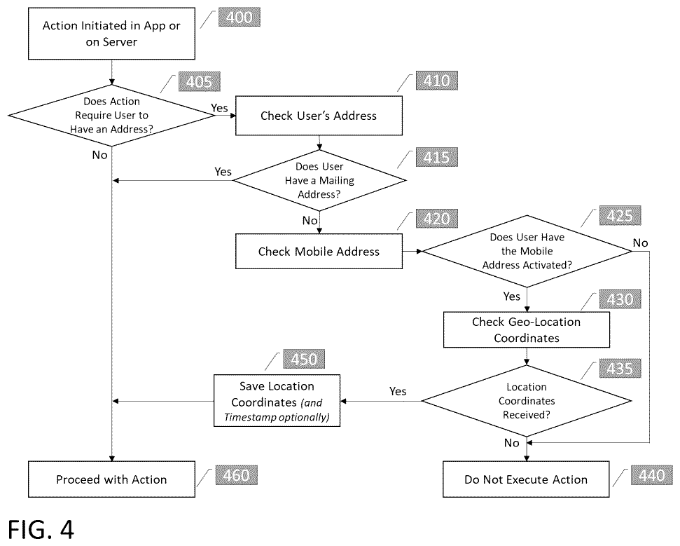

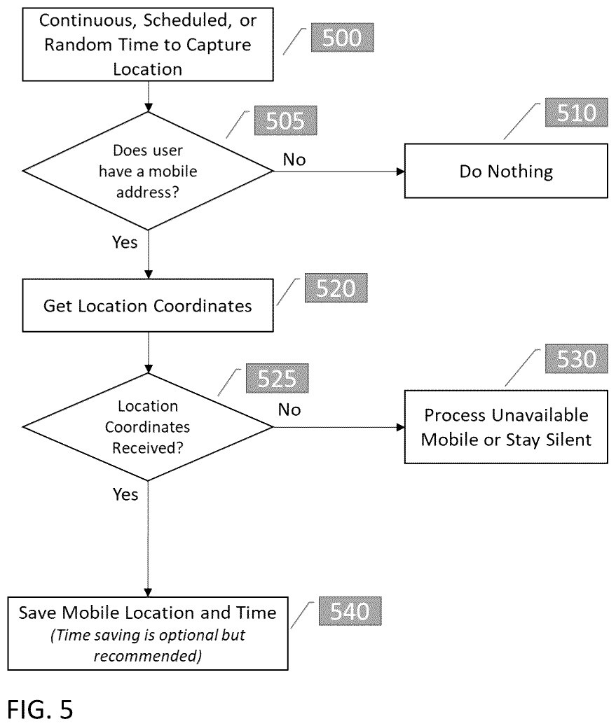

The following will provide detailed descriptions of the processes and steps involved in using the innovation, starting with the selection to use a mobile address depicted in FIG. 1. FIG. 2 will present an example of database and tables to store the mobile address election and transactions, while FIG. 3 will show an example of a user interface for selecting the mobile address. FIG. 4 will explain how to execute an action requiring a user to have an address in the system. Finally, FIG. 5 will explain how to capture the user's mobile address at a continuous, scheduled, or random time.

When an app or a system needs to store the user's address in its database, it requires the user to first enter such address. FIG. 1 is a flowchart representing the process of registering a user's address in general and particularly their mobile address. It starts with the need for the user to enter their address 100. If the user has a mailing address 105, they enter it in the traditional way 110 and the user's address provided 150 is saved either locally or on a server database, so it can consistently be used later. If the user does not have a mailing address in step 105, through this invention, they will have the option to select to use their mobile address 120. The user can simply click or select the checkbox, or any other option allowing the app to use their mobile address. The selection can also be made using a drop-down list, or it can use any other element in the app allowing the user to decide on using their mobile address 125, thus confirming that they want their actions to be stored along with the location where the action occurred, and they also accept their location to be reported to the server randomly or at scheduled times. Such a disclaimer should be made available to the user and should be included in the privacy policy and terms of use as a good practice. If the user opts not to use their mobile address at this point 130, they will simply be un-addressable, and the app's requirements will determine the next step. In case the user opts to use their mobile address by clicking on the visual elements (e.g., checkbox) or by using any other mechanism provided by the app 140, the selected option is saved in the local or remote database table 150 and the user is considered addressable.

Saving the user's option to use their mobile address is generally done on the server, but it can also be done locally if the app stores this type of information in a local data-retaining structure, which can be a database table, a file, any local storage of a mobile device, etc. FIG. 2 depicts a possible solution out of many, for storing such information in database tables. Note that this illustration is not the only way of implementing the invention, as the naming and structuring of the information depends on the software developer and will vary from one developer to another, and from one language to another. This presentation is made to explain the logic of the storage and utilization of the mobile address. Again, the final deployment can use just part of the illustration with different appellations, but it still stays the same invention.

When storing the user's selection to use their mobile address in the database 200, a table can be used. This table can be the users table 210, the user settings table 220, or any other table deemed necessary by the app developer or database administrator. There is no limitation as to the name of the table storing the information. Indeed, the developer can simply decide to reuse the existing address fields with an option indicating that the user selected to use their mobile address. An example could be: “setting the user's country code to zero means we will use the user's mobile address”. As presented by this example, there is no limit to creativity in representing the selection of the mobile address in a database.

With the user's option to use their mobile address stored on a table as presented, the mobile address itself will also need to be stored in the database or any other structure. This can be done on one or many tables, files, or mobile storage. For example, the app can include a mobile-addresses table 230 that will store all location coordinates captured for the users. It can also decide to save the information as part of the transactions table 240, along with other details of the transaction. Once again, the illustration in FIG. 2 shows an example of implementation, but there is an unlimited number of possibilities in terms of tables, naming, and representation of the data. For example, one developer can opt to represent location coordinates in one field containing a text, CSV, or JSON information, while another developer can opt to break down the structure of location coordinates in terms of latitude and longitude, or even add altitude, accuracy, etc. Regardless of the fields stored and their representation, these implementations are still part of the same invention as they are used with the idea of representing the user's mobile address.

FIG. 3 depicts an example of user interface, showing how a user can select to use a mobile address 310 instead of a mailing address through a checkbox. Other options not depicted include the selection of the user's mobile address using a dropdown list, a picker, a select list, or any other selection method provided by the application interface. Once the user checks the checkbox labeled “I have no mailing address; Use my Mobile Address instead” or any other option allowing them to select to use their mobile address, some address input elements could be grayed out 320, such as Address Line 1, Address Line 2, and Zip or Postal Code. Again, this is just an example, and the app developer could select to leave them present, make them invisible, show a different screen, or any other option they want. The invention here is about giving the user the option to use their mobile address in replacement of or addition to their mailing address, regardless of the method implemented for the selection. As previously stated, once the user opts to use their mobile address, the app could still request any combination of the mailing address fields or none of them. Indeed, with the location coordinates, an application can still determine the related country by using existing algorithms and packages not considered part of this invention. Still looking at this example, three fields are required to be filled 330 namely City, State or Province, and Country. Once the user selects to save their address by clicking on the Save Address button 350, the app saves the selected option as indicated in 140 in the database table as shown in 210 or 220 for an alternate implementation.

Once the user has opted to use their mobile address and the setting is saved in the database or any other structure that can contain such election, actions requiring the user to have an address can be executed as shown on the flowchart in FIG. 4. It starts with an action initiated in the app or on the server 400. An example of action could be sending money from one user's account to another user, requiring the sender to have previously saved their address. Another action could be to add a person to a user's contact list, which does not require the user to have entered their address. In both cases, the app would check if the action required the user to have an address 405. If not, it would proceed with the action 460. If on the contrary it requires the user to have an address, the user's address would be checked 410. If the user has a mailing address in the database 415, the action proceeds by going to 460. If not, the mobile address will need to be checked 420. If the user does not have the option to use their mobile address 425, do not execute the action 440. Else, check if the geolocation coordinates were received from the mobile device 435. If the coordinates were not received, do not execute the action 440. If they were received, save the coordinates in the database 450 and proceed with the action 460. It is important to note that in a different implementation, steps 450 and 460 could be combined, or step 450 could be placed after step 460.

FIG. 5 shows a flowchart for the process of collecting user location to continuously inform their mobile address. At a continuous, scheduled, or random timeframe on step 500, the server or the mobile app is triggered. First, it checks if the user has a mobile address on step 505. If they do not, step 510 suggests doing nothing and the process ends there. If the user has a mobile address, step 520 recommends making sure the user's location coordinates are received and sent to the server. As such, step 525 checks if the location coordinates are received. If not, process the unavailable mobile on step 530. Such processing could also consist of staying silent. One can implement a minimum threshold for receiving random and/or scheduled location data per day, week, month, or year. If such process is implemented, it would inform step 530. As a note, in a continuous timeframe, the application or a part of it runs in the background to continuously capture the user's location.

If the location coordinates were received in step 525, save the mobile location and time in step 540. Saving the time is discretionary, but valuable for most applications. It should be noted that a different implementation could consist of saving the coordinates locally on the mobile device and sending them later to the server. As presented, there are multiple possibilities of implementing the invention and the developer will ultimately select the one that best fits the needs of their application.

While this process of capturing the user's location randomly, continuously, or at specific times is important in ensuring proper information of the users' mobile address, not implementing it does not mean this invention was not used. The invention is considered consumed as soon as an app makes use of the concept of mobile address whereby the user's location coordinates are used as an address. As such, it is quite possible to use just one location coordinate record as the user's mobile address in some implementations of the invention.

The preceding description of embodiments serves as an illustration and overview of the invention's capabilities. While the description offers a detailed view of several possible embodiments of the invention, it should not be considered an exhaustive list of all possible implementations. Rather, the description is intended to provide guidance and inspiration to those skilled in the art, who may use this information to develop their own unique applications based on the principles and concepts underlying the invention.

It is worth noting that the invention's versatility means that it can be modified and adapted to suit a variety of different use cases and contexts. Users should not feel limited by the specific embodiments described in this document but should instead be inspired to consider how the principles and features described here can be leveraged in new and innovative ways.

One of the key advantages of the invention is its adaptability to different operating conditions and arrangements. The embodiments described in this document are only a starting point, and users are encouraged to experiment with different designs and configurations in order to find the best fit for their particular needs.

Overall, the description of embodiments presented here should be seen as a starting point for exploring the possibilities of the invention. It is intended to inspire and guide users as they develop new and exciting applications, and should not be seen as a strict limitation on the invention's potential. The invention's scope is defined by the appended claims, which should be interpreted broadly to encompass all possible variations and adaptations.

1. A method for allowing mobile applications to use the locations of users' mobile devices as a form of address in combination with or replacement of a mailing address or its sub-components, comprising the steps of:
a. allowing the user to select their mobile address instead of, or in addition to a home address, work address, or any other traditional mailing address, including the steps performed in saving the user's election to use their mobile address in a database table or any other storage structure,
b. storing the mobile address as geolocation coordinates in a data structure with the intent of replacing or complementing any traditional address,
c. updating the mobile address, wherein the mobile address is updated with additional location coordinates continuously or at scheduled or random times,
d. mandating the presence of the user's geolocation coordinates in transactions and processes implemented by a software application for users with a mobile address,
e. saving location coordinates while executing an action or rejecting the action execution in the absence of the coordinates for users electing to use a mobile address.

2. The method of claim 1 under the appellation “mobile address” or any other appellation deemed necessary in the implementation of the method, with the understanding that the mobile address is one or multiple geographic location coordinates of a user, timestamped or not, allowing to identify their locations in general or at specific times as needed, used as an alternate form of address with the propensity to serve as a mean for identity verification, validation, or confirmation.
